(19) United States
(12) Patent Application Publication
(10) Pub. No.: US 2009/0300026 A1
(43) Pub. Date: Dec. 3, 2009

(54) APPARATUS, METHOD, AND SYSTEM FOR INFORMATION PROVISION, AND STORAGE MEDIUM

(75) Inventor: Takahiro MASUDA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/363,051

(22) Filed: Jan. 30, 2009

(30) Foreign Application Priority Data
May 30, 2008 (JP) 2008-143842

(51) Int. Cl. G06F 17/30

(52) U.S. Cl. 707/10; 707/E17.032

(57) ABSTRACT

An apparatus, a method, a program, and a system for providing information to information terminal within a certain area such as a vehicle are provided to identify an area with area identification information (e.g., vehicle identification graphic) disposed in the certain area and to provide area attribute information concerning at least the area to one or a plurality of information terminals (user terminals) issuing information requests including the area identification information from inside the area to achieve stabilization of information provision and acceleration of information provision within the area.

### CROSS-REFERENCE TO RELATED APPLICATIONS

This application is based upon and claims the benefit of priority from the prior Japanese Patent Application No. 2008-143842, filed on May 30, 2008, the entire contents of which are incorporated herein by reference.

### FIELD

The present invention relates generally to information provision to terminals within a certain area such as a vehicle or building, and, more particularly, to an information providing apparatus, an information providing method, an information providing program, an information providing system, and storage medium used for provision of various pieces of information such as operation diagram information, route information, and transfer information corresponding to an information request from a certain area such as a vehicle or building.

### BACKGROUND

If GPS (global positioning system), etc., are used as a form of providing information, data of current location may be acquired and, by transmitting the current location information, various pieces of information may also be acquired such as a map around the current location, a route from the current location to a destination, and addresses of facilities around the current location or major facilities.

For example, a portal site, “transit.yahoo.co.jp” discloses information provision that enables display of various pieces of information such as peripheral maps, accommodation facilities, and coupons as information of a departure station, transit stations, and a destination station when specifying the departure station and the destination station in a route information service.

Japanese Patent Application Laid-Open Publication No. 2000-163689 discloses that a temporal margin and a traveling means are input to obtain the time required for visiting a facility contained in circumferential information from circumferential information and map information of an arbitrary position and to retrieve and display the facility which can be reached within the temporal margin by comparing the temporal margin and the required time (Abstract, FIG. 1, etc.).

Japanese Patent Application Laid-Open Publication No. 2003-48543 discloses that operation data are automatically set by calculating a train position with the use of the position coordinate information provided from a position information satellite and by transmitting the train number and operation data to the train for storage in an on-board operation pattern server on the basis of the train position and the organization number of the train (Abstract, FIG. 1, etc.).

Japanese Patent Application Laid-Open Publication No. 10-276217 discloses connecting a mobile station (railroad vehicle) provided with a in-vehicle LAN system and a base station wirelessly, managing IP addresses of a plurality of LAN terminals making up the in-vehicle LAN system as well as an operating state of the vehicle in the base station, specifying a valid period of an IP address based on the on-track time information of the vehicle for an IP address setting request from the LAN terminal, and allocating the IP address to the LAN terminal (Abstract, FIG. 1, etc.).

In a certain area, for example, in a mobile object such as a train or bus vehicle, it is useful to obtain information about operation, stops, etc., of the vehicle. However, if information is transferred between the mobile object and the outside through electric waves, the electric waves are blocked by the mobile object and it is disadvantageous that the acquisition of information becomes unstable if a stable connection state cannot be maintained.

In a vehicle such as a train, when a current location is within the vehicle at a passing station, it is requested to acquire information used after getting off the vehicle such as information about the destination station, the surrounding thereof, etc., before getting off the vehicle. If the information constructed based on a passing point such as a passing station, errors may be generated in the acquired information, and it is problematic in the information acquisition that whether a passing station, etc., may be defined as a starting point of an activity may not be used in the vehicle as a decision element to acquire information.

“transit.yahoo.co.jp” and Japanese Patent Application Laid-Open Publication Nos. 2000-163689, 2003-48543, and 10-276217 do not disclose or suggest the requirement and the problem as well as a configuration, etc., for resolving the requirement and the problem.

### SUMMARY

Aspects of embodiments of the invention provide an information providing apparatus, an information providing method, an information providing program, and an information providing system for providing information to information terminal within a certain area such as a vehicle, which include identifying an area with area identification information (e.g., vehicle identification graphic) disposed in the certain area, and providing area attribute information concerning at least the area to one or a plurality of information terminals (user terminals) issuing information requests including the area identification information from inside the area to achieve stabilization of information provision and acceleration of information provision within the area.

An information providing apparatus of an aspect of an embodiment of the invention includes a storage unit that stores thereon area identification information identifying an area in which the information providing apparatus is disposed; and an information providing unit that provides area attribute information concerning at least the area toward one or a plurality of information terminals that issue information requests including the area identification information.

With such a structure, when the information providing unit accepts the information request including the area identification information from the information terminal in the area, the area attribute information about the area may be provided to the information terminal and the area attribute information may stably be provided. If the area is a vehicle, the area attribute information is a line name, a type, a terminal station, and a vehicle number concerning the vehicle, and a cause of a delay and a delay time taking the delay into consideration if a delay occurs.

An information providing method of an aspect of an embodiment of the invention includes acquiring area identification information of a certain area; issuing an information request including the area identification information from an information terminal; and providing area attribute information concerning at least the area from an information providing unit toward the information terminal.

A computer-readable storage medium of an aspect of the invention is a computer-readable storage medium storing an information providing program executable by a computer, the program including the steps of acquiring area identification information of a certain area; issuing an information request including the area identification information from an information terminal; and providing area attribute information concerning at least the area from an information providing unit to the information terminal.

An information providing system of an aspect of an embodiment of the invention is an information providing system providing information to information terminals at least within an area, including a storage unit that stores thereon area identification information identifying the area; one or a plurality of information terminals that issue information request including the area identification information to acquire information corresponding to the information request; an information providing unit that provides area attribute information concerning at least the area when the information terminal issues the information request; and an information relaying unit that is disposed in the area, is connected to the information terminal and/or the information providing unit through a network, and relays the information request issued from the information terminal and response information provided from the information providing unit in response to the information request.

The advantages of the invention will be realized and attained by means of the elements and combinations particularly pointed out in the claims.

It is to be understood that both the foregoing general description and the following detailed description are exemplary and explanatory and are not restrictive of the invention, as claimed.

Other features and advantages of the embodiments of the invention will become more apparent by reference to the accompanying drawings and embodiments.

### BRIEF DESCRIPTION OF DRAWINGS

FIG. 1 is a diagram of an information providing system according to a first embodiment;

FIG. 2 is a diagram of a sequence of process procedure of information provision;

FIG. 3 is a flowchart of a process processing procedure;

FIG. 4 is a diagram of an exemplary configuration of an information terminal;

FIG. 5 is a flowchart of a utilization start process procedure;

FIG. 6 is a flowchart of a utilization termination process procedure;

FIG. 7 is a flowchart of a process item selection process procedure;

FIG. 8 is a flowchart of a process procedure at the end of session;

FIG. 9 is a diagram of an exemplary configuration of an information aggregation server;

FIG. 10 is a flowchart of a communication start process procedure;

FIG. 11 is a flowchart of a communication termination process procedure;

FIG. 12 is a diagram of an exemplary configuration of a main server;

FIG. 13 is a flowchart of an information acquisition process procedure;

FIG. 14 is a diagram of an exemplary configuration of an event server;

FIG. 15 is a flowchart of a user registration process procedure;

FIG. 16 is a flowchart of an information device registration process procedure;

FIG. 17 is a flowchart of an event reference process procedure;

FIG. 18 is a flowchart of an event information process procedure;

FIG. 19 is a diagram of an information providing system according to a second embodiment;

FIG. 20 is a diagram of an information providing system according to a third embodiment;

FIG. 21 is a diagram of an information providing system according to a fourth embodiment;

FIG. 22 is a diagram of an information providing system according to a fifth embodiment;

FIG. 23 is a diagram of hardware of a user terminal;

FIG. 24 is a diagram of a portable device;

FIG. 25 is a diagram of a personal computer;

FIG. 26 is a diagram of a PDA; and

FIG. 27 is a diagram of a computer.

### DESCRIPTION OF EMBODIMENTS

### [a] First Embodiment

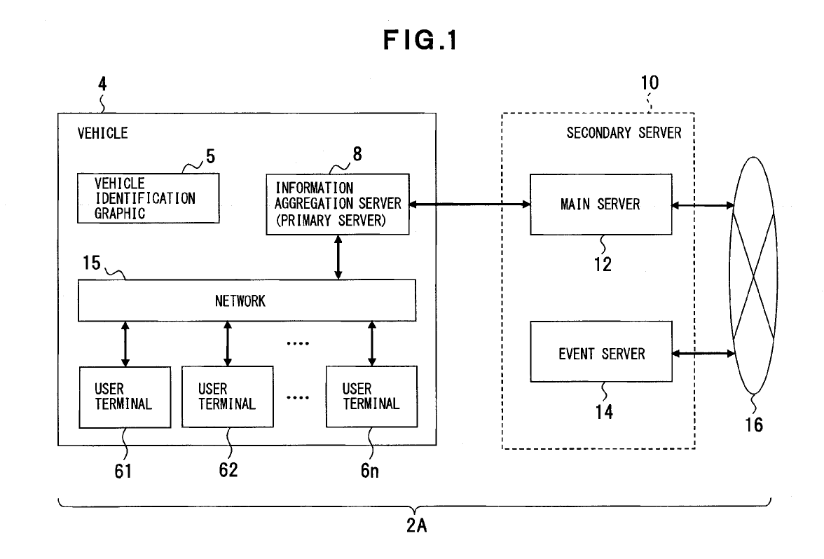

A first embodiment will be described with reference to FIG. 1. FIG. 1 is a diagram of an information providing system. The configuration depicted in FIG. 1 is by way of example and the present invention is not limited to this configuration.

An information providing system 2A is an example of an information providing apparatus, an information providing method, an information providing program, and an information providing system of the present embodiments and is a system connecting to an information providing means (information providing unit) through an information relaying means (information relaying unit) in a certain area in response to an information request including area identification information from an information terminal of a user (e.g., passenger) in a certain area such as a vehicle to provide area attribute information and other pieces of information (including information concerning the area attribute information) provided from the information providing means as response information to the information terminal.

As depicted in FIG. 1, the information providing system 2A includes a vehicle identification graphic 5 disposed in a vehicle 4, one or a plurality of user terminals 61, 62, . . . 6n, an information aggregation server 8 acting as a primary server (information relaying means) disposed in the vehicle 4, a main server 12 acting as a secondary server 10 that is an information source outside of the vehicle 4, and an event server 14, and the main server 12 and the event server 14 are connected to a network 16.

The vehicle 4 is an example of the certain area and a storage means (storage unit) that stores the vehicle identification graphic 5, which is an example of the area identification information, may be an area partitioned into a certain region, for example, the inside of a mobile object such as a vehicle, and may be a compartment of a mobile object, a certain land area, a certain building, or a certain room in a building. In this example, the vehicle 4 covers vehicles running on tracks as well as buses, trains, and transportations in general available to passengers, such as taxies, ships, and airplanes. The tracks are routes, seaways, etc., predefined for the purpose of being utilized by vehicles. For example, since a route at the time of using a taxi may be considered as a road for taking a tour of major spots for the purpose of guiding a sightseeing tour, the taxi is included in the vehicles of the embodiment of the invention. Passengers are customers getting on and utilizing the vehicle and users who utilize the user terminals 61, 62, . . . 6n.

A vehicle type in the information about the vehicle 4 indicates a stop pattern of the vehicle utilizing the same track, such as “local”, “rapid”, “express”, and “special express” and also includes information about a seat type such as “class of sleeper compartment”, “reserved seat”, and “Green Car”, as needed.

The vehicle identification graphic 5 is an example of area identification information that identifies the area described above, i.e., the area with the own apparatus (the information aggregation server 8 that is an example of the information providing apparatus in this case) disposed, or vehicle identification information that identifies a vehicle serving as an example in the area, is a graphic visible to users at inside of vehicles 4, and is information such as a company the vehicle belongs to, a type of the vehicle, a line the vehicle travels on, and the car number of the vehicle. Identifying the vehicle 4 enables identification of what company the vehicle belongs to, what line the vehicle travels on, and a type of the vehicle (such as local or express), and enables identification of what time the vehicle leaves the starting station on schedule. The area identification information or the vehicle identification information may be character strings such as symbols and numeric characters other than the vehicle identification graphic 5, may be combination of the character strings and the vehicle identification graphics 5 or may be those graphically representing identification codes such as bar-codes or two-dimensional codes. As long as the area identification information or the vehicle identification information may be identified, the vehicle identification graphic 5 may be a fixed graphic, for example, those never changed after once assigned until the vehicle is scrapped, or sold or may be a floating graphic, for example, those changed for every departure from the starting station.

The user terminals 61, 62, . . . 6n are examples of information terminals used by passengers, the conductor, etc., in the vehicle 4 and are mobile communication devices capable of communication for transmitting/receiving information, for example, portable information terminals. The portable information terminals are information processing devices brought into and usable in the vehicle such as mobile telephones, personal digital assistant (PDA), and notebook personal computers. In the present embodiment, a communication function is provided through a means not requiring a transmission line such as electric wave or infrared light. The user terminals 61, 62, . . . 6n are connected to the information aggregation server 8 through a network 15 as communication line means in a wired or wireless manner and are also connected to the event server 14 through the network 16.

The public telephone lines are utilized as the above-described network 15 for a communicating means between the user terminals 61, 62, . . . 6n and the information aggregation server 8, and URL is assigned to the information aggregation server 8 to enable access to the information aggregation server 8 from terminals capable of utilizing the Internet. Other usable communication means include a wireless LAN as well as communication using infrared light or visible light. IrDA, etc., may be used in the communication using infrared light or visible light to achieve connection with the information aggregation server 8 and, in this case, an IrDA device may be disposed near the ceiling of the vehicle 4. When utilizing the wireless LAN, for example, equipments conforming to the 802.11x standard may be mounted to enable access to the information aggregation server 8 from terminals capable of utilizing close range wireless communication such as wireless LAN.

The information aggregation server 8 is an example of an information processing means that transmits/receives information to/from the user terminals 61, 62, . . . 6n, also acts as a relay device, makes up a primary server with respect to the secondary server 10, and is disposed for each vehicle 4. The information aggregation server 8 accepts a unique ID assigned as identification information to each of passengers or the user terminals 61, 62, . . . 6n and an information provision request from the user terminals 61, 62, . . . 6n. When accepting the information provision request, the information aggregation server 8 acquires “detailed vehicle unique information” and information such as “vehicle operation information” as needed. In this case, if a delay occurs in the vehicle 4, an inquiry is made to another server, i.e., the main server 12 of the secondary server 10 to check whether schedules of passengers are affected, and the inquiry result is processed into response information and presented to, for example, the user terminal 61 of the passenger who made the information provision request among the user terminals 61, 62, . . . 6n.

The “detailed vehicle unique information” acquired by the information aggregation server 8 is information for identifying the vehicle and this information is delivered to the main server 12 for acquiring operation information of the vehicle and to specify what vehicle the information about operation is desired for. Information about the “vehicle schedule” is included along with information of the management company and the line of the vehicle. Specifically, the “vehicle schedule” is information indicative of, for example, that the train is the rapid train to a station B departs from a station A at what clock time on the operational diagram, how many vehicles make up the train, and what number the vehicle is from the front.

The “vehicle operation information” is information indicative of what state a certain vehicle is currently operated in and it must be specified what vehicle is the target of information acquisition. Specifically, the information is a difference between the “vehicle schedule” and actual operation, a current speed of the vehicle, a position where the vehicle currently travels at, and information about a delay if a delay occurs.

The main server 12 is an information management server disposed in a management center, for example, a control room that manages the vehicle 4 as a certain area and makes up an information provision server that provides information for the information provision request from the information aggregation server 8. The control room is a facility capable of collecting information about a current location, etc., of vehicles possessed by a railroad company, etc., and giving instructions to change operation plans defined for vehicles as needed. The main server 12 has functions of accepting information requests for operation information request, etc., along with unique information of each vehicle 4 from the information aggregation server 8 located in each vehicle, acquiring various pieces of operation information including delay information, etc., of the vehicle 4, and returning the acquired information to the information aggregation server 8 emitting the information request.

The main server 12 is connected to the information aggregation server 8 to transmit/receive information through the VHF communication with the use of a leaky coaxial cable, etc. The main server 12 is connected to the network 16 such as the Internet and has functions of acquiring various pieces of information published over the network 16 and presenting the information to the user terminals 61, 62, . . . 6n and/or the information aggregation server 8.

The event server 14 is an information provision server arbitrarily disposed and provides information for the information provision request from the information aggregation server 8. The event server 14 preliminarily acquires schedule information of passengers from the user terminals 61, 62, . . . 6n and saves the schedule information. The schedule information is correlated with unique ID assigned to each passenger and is saved.

The event server 14 is connected to the network 16 and has functions of acquiring various pieces of information published over the network 16 and presenting the information to the user terminals 61, 62, . . . 6n and/or the information aggregation server 8.

To utilize this information providing system 2A, as preparatory thereof, a user may preliminarily register user information and information about user's preference, etc. The information about user's preference, etc., maybe utilized for a selection condition of information required for a user in the acquired information and, therefore, serves as one piece of selection information. Such information may be registered to the event server 14 with the using of user terminals such as the user terminals 61, 62, . . . 6n.

The information aggregation server 8 accepts the information requests from the user terminals 61, 62, . . . 6n of users (passengers) in the vehicles 4. The network 15 such as a wireless network using electric waves, infrared light, etc., is established in the vehicle 4, and the information aggregation server 8 and the user terminals 61, 62, . . . 6n in the vehicle 4 are connected through the network 15 to enable transmission/reception of information. In this case, although passengers safety is considered of course and it is set not to be available in a certain vehicle or around certain seats (such priority seats), wired connection may be set to be selectable if it is not preferable to utilize radio transmission. It is desirable that the information aggregation server 8 ensures sufficient line quality for transmission/reception of information with external information sources.

Fixed information such as “line name (name or identifier, etc.)” and “type (local, rapid, etc.)” is registered in the information aggregation server 8. Information such as “next station name (name or identifier, etc.)”, “scheduled stop clock time at next stop”, and “current state of vehicle (such as normal operation, stop due to signal, and stop for yy minutes due to vehicle trouble) ” is supplied and configured such that users may always utilize the information from the user terminals 61, 62, . . . 6n.

In the actual utilization stage after the above preliminary stage, information about the current location and information provided by GPS (global positioning system), the control room, etc., are acquired from the main server 12, and various pieces of information are registered in the information aggregation server 8 of the vehicle 4, such as “next station name and information about that station, and information about facilities around the station” and “scheduled stop clock time in the normal operation”. If operation is not normal due to accident, etc., information about the cause and the prospect of recovery is acquired as traffic information from the operator or manager of the vehicle, the control room, etc., to register these pieces of information into the information aggregation server 8.

If a user emits an information request to the information aggregation server 8 with the use of the user terminal 61, 62, . . . 6n to receive provision of necessary information, the information aggregation server 8 accepts the information request. The information aggregation server 8 receives provision of various pieces of information from the main server 12 and the event server 14 as well as external servers through the network 16. The provided information contains information about preference of the user emitting the request.

If the selection information correlated with the user is registered in the event server 14, the event server 14 executes a filtering process with the selection information such as user's preference based on the acquired information to select and provide the information required for the user to the information aggregation server 8.

The information acquired by the main server and the information acquired by the event server 14 are processed by the information aggregation server 8 and provided to the user terminal 61, 62, . . . 6n that emitted the information request.

The selection information may be registered in the information aggregation server 8 to execute the filtering process with the selection information about user's preference, etc., in the information aggregation server 8 and to present the result of the filtering to the user in some configurations.

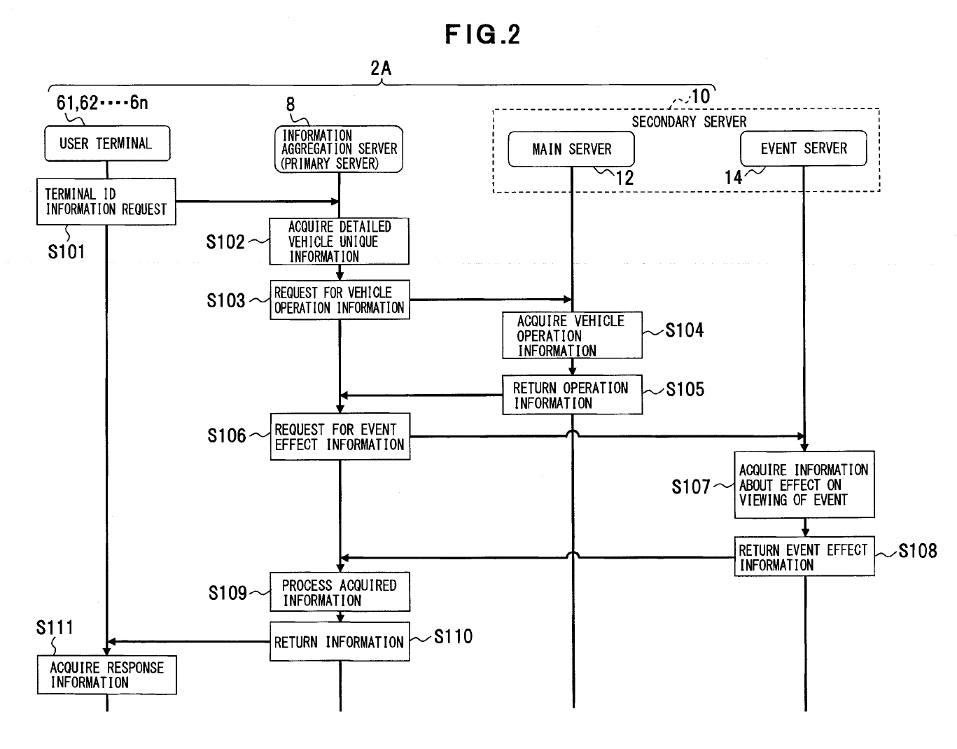

The information provision of the information providing system 2A will be described with FIG. 2. FIG. 2 is a diagram of a sequence of process procedure of the information provision. The configuration depicted in FIG. 2 is by way of example and the present invention is not limited to this configuration.

This process procedure of the information provision is an example of the information providing method and the information providing program, and an information provision request from a passenger is made through the user terminals 61 to 6n and the response information is provided from the information aggregation server 8 for the information provision request. Each step corresponds to a process step of the information processing method.

In the process procedure of the information provision, as depicted in FIG. 2, a terminal ID and an information request are emitted from one of the user terminals 61 to 6n to the information aggregation server 8 (step S101), and the information aggregation server 8 accepts this information request, acquires detailed vehicle unique information (step S102), and requests the main server 12 for the vehicle operation information (step S103). The detailed vehicle unique information and the vehicle operation information are as described above.

The main server 12 accepts the operation information request, acquires the vehicle operation information (step S104), and returns the operation information to the information aggregation server 8 (step S105). This response of the operation information triggers the information aggregation server 8 to emit a request for event effect information to the event server 14 (step S106), and the event server 14 accepts the event effect information request, acquire information about effect on viewing of the event (step S107), and returns the event effect information to the information aggregation server 8 (step S108).

The information aggregation server 8 processes the acquired information (step S109), for example, to convert the acquired information into an easily viewable form in this process and returns the information to the user terminal requesting the information (step S110). The user terminal acquires the response information corresponding to the information request (step S111) to recognize the contents.

In this process procedure, the “information about effect on event viewing” is information provided by the event server 14. When making a change in transportation facilities such as train, for example, this may be resolved by the above process procedure if this is construed as an event of arriving at platform No. d of a line c to be used after the making the change in a station ab where the change is made at a certain clock time.

In this case, forms of utilization of the service will roughly be classified to 1) the case that an event is identified, i.e., the case that one wants to know whether a currently occurring delay affects arrival before the start time of the event already registered, and 2) the case that an event is not identified, i.e., the case that one wants to list viewable events held around the destination station if a train arrives at the exit station at a clock time taking the currently occurring delay into consideration.

In the case of 1), if the event is identified, the event to be viewed may preliminarily be registered in the event server 14. If a delay occurs in the vehicle currently taken by a user, the user may inquire whether the delay makes any trouble in viewing of the registered event. If the user cannot arrive before the event start time, this may be communicated to the user (passenger) who is the inquirer.

In the case of 2), if the event is not identified, a user may specify the exit station. The event server 14 uses the information about the current vehicle operation state to determine the actual arrival time at the station and lists the events that the user can arrive before the start times among events accessible from the station. In this case, a list may also be generated for events that the user can arrive before the closing times. This list is useful for events such as art museum with the closing times more important than the start times.

When generating a list, the priorities of events are obtained and displayed according to the preference and tendency by registering the preference and tendency of the user as the selection information and making a reference to the selection information. Whether an event does not reach the level that the user wants to display may be used as a criterion of judgment, and if a value of the priority ranking is smaller than a certain value, the event may not be displayed.

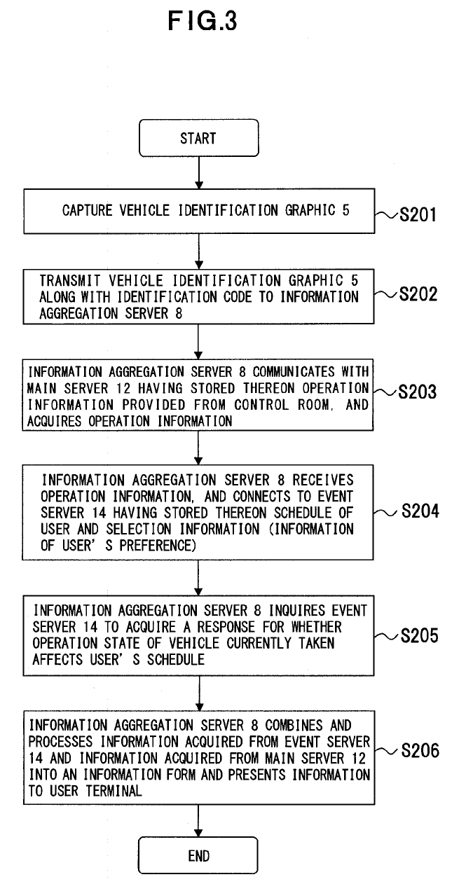

The process processing procedure will be described with reference to FIG. 3. FIG. 3 is a flowchart of the process processing procedure. The configuration depicted in FIG. 3 is by way of example and the present invention is not limited to this configuration.

The process procedure of the process corresponding to the above sequence (FIG. 2) is an example of the information providing method or the information providing program, and as depicted in FIG. 3, a user (passenger) of a vehicle captures the vehicle identification graphic 5 into the user terminal (step S201) and transmits an information provision request to the information aggregation server 8 along with the acquired vehicle identification graphic 5 and the identification code (identification information) assigned to the user terminal (step S202). In this case, when the vehicle identification graphic 5 and the identification code are transmitted, these may make up the information provision request. The information aggregation server 8 receives the vehicle identification graphic 5 and the identification code, communicates with the main server 12 having stored thereon the operation information provided from the control room, and acquire the operation information from the main server 12 (step S203). The information aggregation server 8 receives the operation information, connects to the event server 14 having stored thereon the schedule of the user (step S204), inquires the event server 14 to acquire a response for whether the operation state of the vehicle currently taken affects the user's schedule (step S205).

The information aggregation server 8 combines the information acquired from the event server 14 and the information acquired from the main server 12, processes them into an information form easily viewed by the user and presents the information to the user terminal (step S206).

If the selection information (such as information of user's preference) is registered in the event server 14 along with the above-described user's schedule in this process, information selected with the selection information is provided. The selection information is information preliminarily registered by the user in the event server 14 to represent selection criteria of acquired information as above.

The capture of the vehicle identification graphic 5 (step S201) in this process procedure is presentation of the identification information of the vehicle 4 and is an information process for identifying which vehicle the source of the information request exists and where the response destination of the information exists.

In this capturing process, numeric characters or character strings may be, for example, a) in a form for a user to input directly and manually the vehicle identification graphic 5 indicated such that a user may read and write for direct and manual input, b) in a form that a user captures, for example, graphical representation such as a two-dimensional code as the vehicle identification graphic 5 with an image input device such as camera and the captured graphical representation is analyzed locally for transmission, c) in a form that a user captures graphical representation such as a two-dimensional code as the vehicle identification graphic 5 with an image input device such as camera, the captured graphical representation is directly transmitted to a server, and the server analyzes the graphic to acquire necessary information, and d) in a form automatically added to the information aggregation server 8 by accessing to the information aggregation server 8 disposed for each of the vehicles 4 without need for a user to input a graphic.

With regard to a communicating means between various transportations and the control room (the information aggregation server 8), a bus location system may utilize the packet communication of mobile telephones or, for example, the technology of 5.8-GHz-DSRC inter-vehicle communication as a means of collecting travel information such as vehicle positions and passing times taken by GPS for each vehicle and collecting the travel information collected for each vehicle.

Trains may utilize an inductive radio mode or a leaky coaxial cable mode. In the inductive radio mode, an inductive wire is disposed along rail tracks for communication in the LF band. In the leaky coaxial cable mode, a leaky coaxial cable is disposed in a long tunnel to for communication in the VHF band. Since the VHF communication generally has a greater amount of transmittable information than the LF communication, the leaky coaxial cable mode may be used.

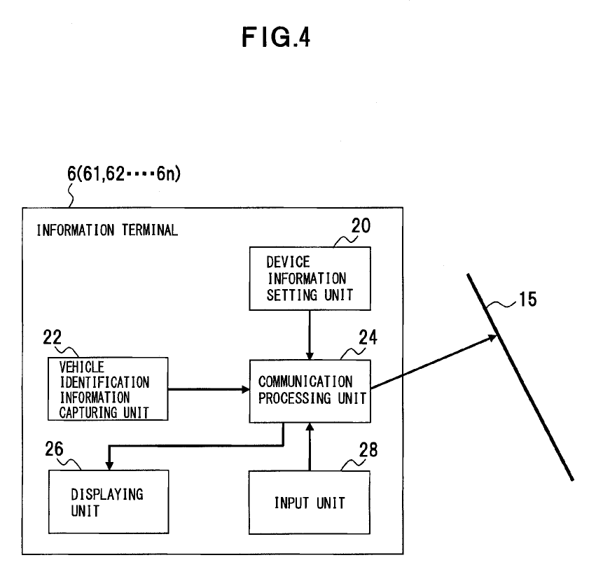

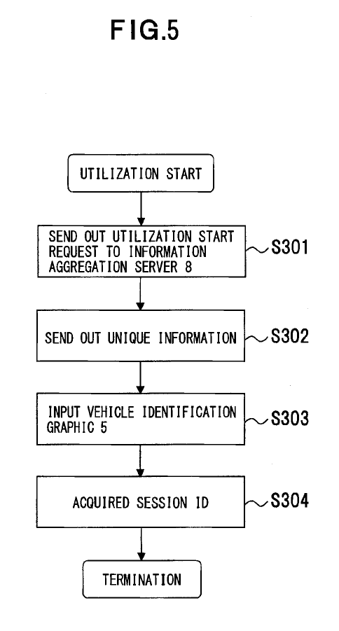

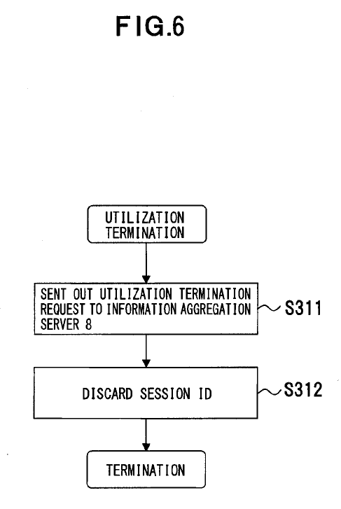

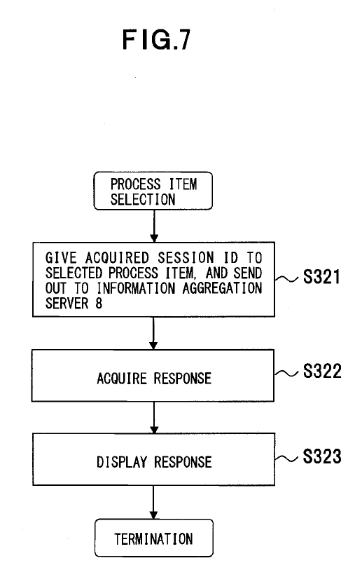

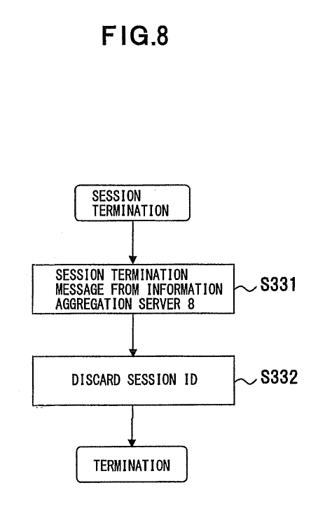

The user terminal will then be described with reference to FIGS. 4, 5, 6, 7, and 8. FIG. 4 is a diagram of an exemplary configuration of an information terminal; FIG. 5 is a flowchart of a utilization start process procedure; FIG. 6 is a flowchart of a utilization termination process procedure; FIG. 7 is a flowchart of a process item selection process procedure; and FIG. 8 is a flowchart of a process procedure at the end of session. The configurations depicted in FIGS. 4, 5, 6, 7, and 8 are by way of example and the present invention is not limited to these configurations. In FIG. 4, the same reference numerals are added to the same portions as FIG. 1.

The user terminals 61 to 6n (FIG. 1) are made up of communicatable information terminals 6 (FIG. 4) used in the vehicle 4 and have a camera function and a transmission/reception function of performing transmission/reception with the information aggregation server 8 acting as an information relaying means. Therefore, the user terminals 61 to 6n may exchange information in a similar manner.

The communicatable information terminal 6 includes a device information setting unit 20, a vehicle identification information capturing unit 22, a communication processing unit 24, a displaying unit 26, and an input unit 28 as depicted in FIG. 4.

The device information setting unit 20 is an example of a device information setting means and has, for example, an identification symbol set as unique information for identifying the information terminal 6.

The vehicle identification information capturing unit 22 is a means of capturing the above-described vehicle identification graphic 5 that is the area identification information and is made up of, for example, a camera that acquires image information of the vehicle identification graphic 5.

The communication processing unit 24 is a wired or wireless communicating means for transmitting/receiving information to/from the information sources such as the information aggregation server 8 and the event server 14, and accesses to the information aggregation server 8 through the network 15 to transmit/receive various pieces of information such as information requests and acquired information in the vehicle 4.

The displaying unit 26 is a presenting means of various pieces of information such as information requests and acquired information and is made up of an LCD (liquid crystal display) displaying device, for example.

The input unit 28 is a means of input for connection and entering various pieces of information such as information requests, and is made up of a keyboard, for example.

To utilize the user terminal 61 to 6n made up of the information terminal 6, a utilization start process (FIG. 5) is executed.

This process procedure is an example of the information providing method and the information providing program and, as depicted in FIG. 5, a utilization start request is sent out to the information aggregation server 8 (step S301); after the request is sent out, the unique information of the user terminal is sent out (step S302); the vehicle identification graphic 5 is input (step S303); a session ID is acquired (step S304); the utilization start process is terminated; and the procedure goes back to the initial state.

If the utilization is terminated, the utilization termination process (FIG. 6) is executed. This process procedure is an example of the information providing method or the information providing program and, as depicted in FIG. 6, a utilization termination request is sent out to the connected information aggregation server 8 (step S311); the acquired session ID is discarded (step S312); and the utilization termination process is completed.

The selection of a process item for the information provision is executed through the process item selection process (FIG. 7). This process procedure is an example of the information providing method and the information providing program and, the selected process item is given the acquired session ID and is sent out to the information aggregation server 8 (step S321); a response is acquired (step S322); the response is displayed (step S323); and the selection process is terminated.

A process of terminating a session is executed through the session termination process (FIG. 8). This process procedure is an example of the information providing method and the information providing program and, a session termination message is received from the information aggregation server 8 (step S331); the session ID is discarded (step S332); and the termination process is completed.

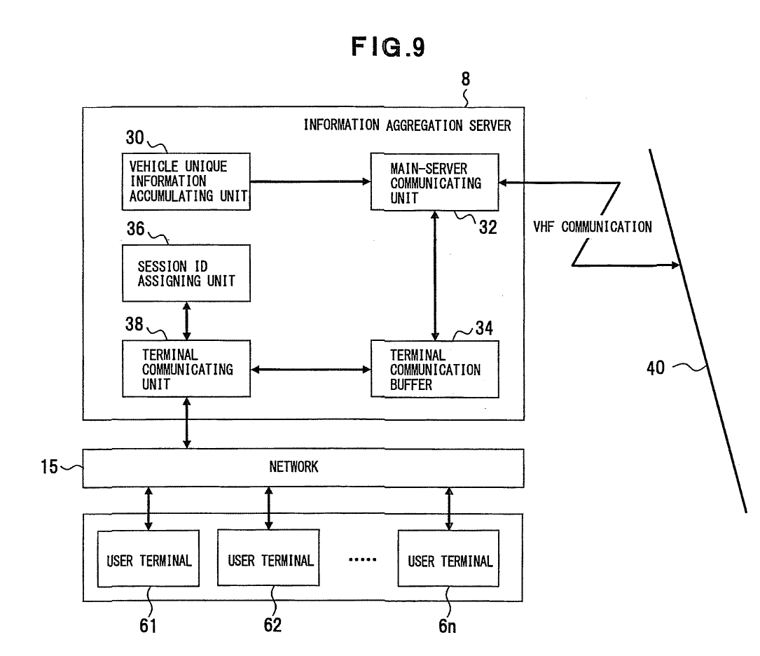

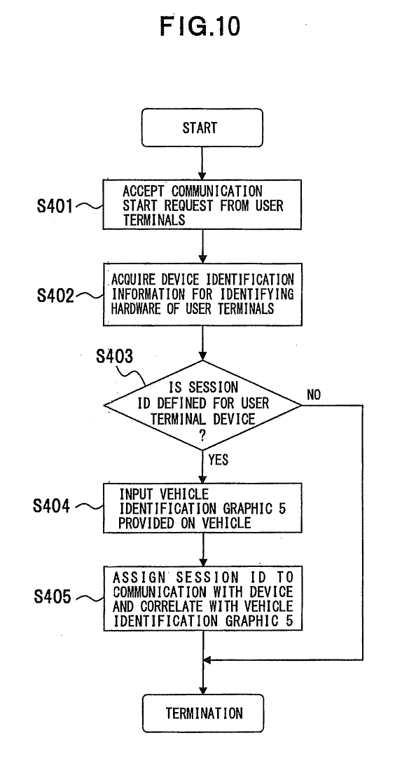

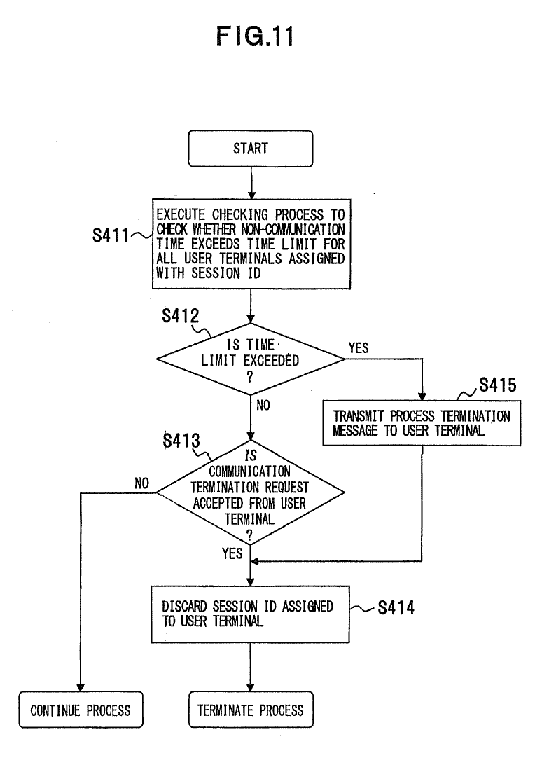

The information aggregation server will then be described with reference to FIGS. 9, 10, and 11. FIG. 9 is a diagram of an exemplary configuration of the information aggregation server; FIG. 10 is a flowchart of a communication start process procedure; and FIG. 11 is a flowchart of a communication termination process procedure. The configurations depicted in FIGS. 9, 10, and 11 are by way of example and the present invention is not limited to these configurations. In FIG. 9, the same reference numerals are added to the same portions as FIG. 1.

The information aggregation server 8 acts as a primary server for the user terminals 61 to 6n to assign unique session IDs, ensures a stable communication path to the main server 12, and is configured as the information relaying means having a buffer function of aggregating communications with the user terminals 61 to 6n. Therefore, as depicted in FIG. 9, the information aggregation server 8 includes a vehicle unique information accumulating unit 30, a main-server communicating unit 32, a terminal communication buffer 34, a session ID assigning unit 36, and a terminal communicating unit 38.

The vehicle unique information accumulating unit 30 is an example of an accumulating means that accumulates the above unique information of the vehicle and registers the vehicle identification code as the vehicle unique information acquired from the main server 12 through the main server communicating unit 32.

The main server communicating unit 32 is a communicating means for the main server 12 and transmits/receives information, for example, through the VHF communication using the leaky coaxial cable (LCX) 40 with the main server 12 and through the wireless communication with the event server 14.

The terminal communication buffer 34 is a buffer means that aggregates communications with the user terminals 61 to 6n as well as a means of relaying information.

The session ID assigning unit 36 is a means that assigns session IDs to the user terminals 61 to 6n requesting information.

The terminal communicating unit 38 is a communicating means connected to the user terminals 61 to 6n through the network 15 such as the public lines and performs communications for receiving information requests from the user terminals 61 to 6n and providing acquired information.

A leaky coaxial cable 40 is disposed along the track of the vehicle 4 to ensure a stable communication path between the user terminals 61 to 6n and the main server 12 and the communication through the VHF band is implemented. In this case, the leaky coaxial cable 40 may be used as an antenna of the main server 12, and an antenna and a communication device necessary for communication with the main server 12 may be disposed on the information aggregation server 8 provided on each of the vehicles 4 for input to the communication interface of the information aggregation server 8.

The information aggregation server 8 executes a relaying process of transmitted/received information as an example of the information providing method and the information providing program, and this relaying process includes a process at the time of the communication start (FIG. 10) and a process at the time of the communication termination (FIG. 11).

In the process procedure at the time of the communication start, as depicted in FIG. 10, a communication start request is accepted from the user terminals 61 to 6n (step S401); device identification information is acquired for identifying, for example, hardware of the user terminals 61 to 6n (step S402); it is determined whether a session ID is defined for the user terminal, i.e., the device of the acquired device identification information (step S403); if the session ID is defined (YES at step S403), the vehicle identification graphic 5 provided on the vehicle 4 is input (step S404); the session ID is assigned to the communication with the device and correlated with the vehicle identification graphic 5 (step S405); and this communication start process is terminated. If the session ID is not defined for the user terminal at step S403 (NO at step S403), this process is terminated.

In the process at the time of the communication termination, as depicted in FIG. 11, a checking process is executed to check whether non-communication time exceeds a time limit for all the user terminals 61 to 6n assigned with the session ID (step S411). In this checking process, it is determined whether the time limit is exceeded (step S412); if the time limit is not exceeded (NO at step S412), it is determined whether a communication termination request is accepted from the user terminal (step S413); and if the communication termination request is accepted (YES at step S413), the session ID assigned to the user terminal is discarded (step S414) to terminate the process.

If the time limit is exceeded (YES at step S412), a process termination message is transmitted to the user terminal (step S415) and the procedure goes to step S414 and, similarly, the session ID assigned to the user terminal is discarded to terminate this communication termination process.

When the time limit is not exceeded, if the communication termination request is not accepted from the user terminal (NO at step S413), this communication process is continued.

At the start and the termination of communication, the information aggregation server 8 always adds a session ID corresponding to the device for the information from the user terminals 61 to 6n and determines “which terminal this inquiry is made by” or “which terminal this response should be transmitted to”.

The information aggregation server 8 once accumulates all the inquiries in the terminal communication buffer 34 and sends the inquiries accumulated in the terminal communication buffer 34 to the main server 12 at certain time intervals. The responses to the inquiries are also accumulated once in the terminal communication buffer 34 and then sent to appropriate destinations. Since the inquiries to the event server 14 are also performed through the main server 12, the inquiries are sent to the main server 12 after adding a tag indicative of that the inquiries are addressed to the event server 14.

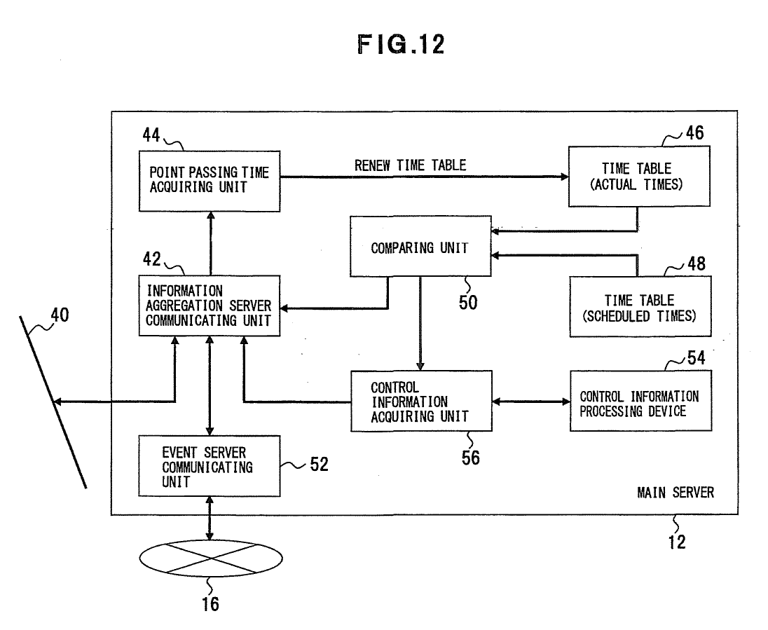

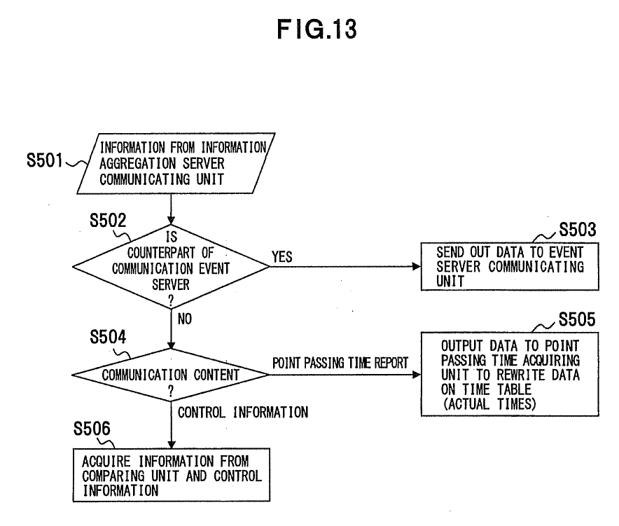

The main server will then be described with reference to FIGS. 12 and 13. FIG. 12 is a diagram of an exemplary configuration of the main server and FIG. 13 is a flowchart of an information acquisition process procedure. The configurations depicted in FIGS. 12 and 13 are by way of example and the present invention is not limited to these configurations. In FIG. 12, the same reference numerals are added to the same portions as FIG. 1.

The main server 12 is a means of providing various pieces of information such as vehicle attribute information in response of an information request from the information aggregation server 8 and includes an information aggregation server communicating unit 42, a point passing time acquiring unit 44, time tables 46 and 48, a comparing unit 50, an event server communicating unit 52, a control information processing device 54, and a control information acquiring unit 56 as depicted in FIG. 12

The information aggregation server communicating unit 42 is a means of communicating with the information aggregation server 8 and transmits/receives information to/from the information aggregation server 8. The point passing time acquiring unit 44 is a means of acquiring passing times at points provided at every certain distances on the lines belonging to a transportation facility.

The time table 46 is a means of accumulating actual times and accumulates actual departure times/arrival times/passing times at stations on the lines belonging to a transportation facility and actual passing times at the points provided at every certain distances on the lines belonging to the transportation facility for all the trains belonging to the transportation facility. The time table 46 is empty for a train not yet traveling at the current time and includes no data for sections not yet actually passed by the train.

The time table 48 is a means of accumulating scheduled times and accumulates scheduled departure times/scheduled arrival times/scheduled passing times at stations on the lines belonging to the transportation facility and scheduled passing times at the points provided at every certain distances on the lines belonging to the transportation facility for all the trains belonging to the transportation facility.

The comparing unit 50 is a calculating means that compares a scheduled time with an actual time to calculate a delay status, compares an actual time in the time table 46 with a scheduled time in the time table 48 to calculate a delay status on all the lines belonging to the transportation facility in real time, and provide the calculation results to the information aggregation server communicating unit 42.

The event server communicating unit 52 is a communicating means that communicates with the event server 14 for transmitting/receiving information and is connected to the event server 14 through the network 16 above.

The control information processing device 54 is a control information processing means of trains, etc., and the control information acquiring unit 56 is provided with the control information from the control information processing device 54 and is provided with information representing a delay status from the comparing unit 50. The control information is delivered from the control information acquiring unit 56 to the information aggregation server communicating unit 42 and is provided to the information aggregation server 8.

If the necessity of recovery from the delay state and a time required for recovering from the delay are known for each train having a delay occurring at the current time, the information thereof is also provided by the main server 12 above. If the travel schedule is changed (e.g., the operation is canceled or the traveling section is changed) for a train among the trains written on the time table 48, information about details of the change is provided through the information aggregation server communicating unit 42 to the information aggregation server 8.

The information acquisition process of the main server 12 is an example of the information providing method and the information providing program and, in the process procedure, as depicted in FIG. 13, information is fetched from the information aggregation server communicating unit 42 (step S501) to determine whether a counterpart of the communication is the event server 14 (step S502), and if the counterpart of the communication is the event server 14 (YES at step S502), data are sent out to the event server communicating unit 52 (step S503).

If the counterpart of the communication is not the event server 14 (NO at step S502), the communication content is determined (step S504); if the communication content is a point passing time report, data are output to the point passing time acquiring unit 44 to rewrite the data on the time table 46 (step S505); and if the communication content is control information, the control information is acquired from the control information acquiring unit 56 and the information representing a comparison result is acquired from the comparing unit 50 that compares time information in the time tables 46 and 48 (step S506).

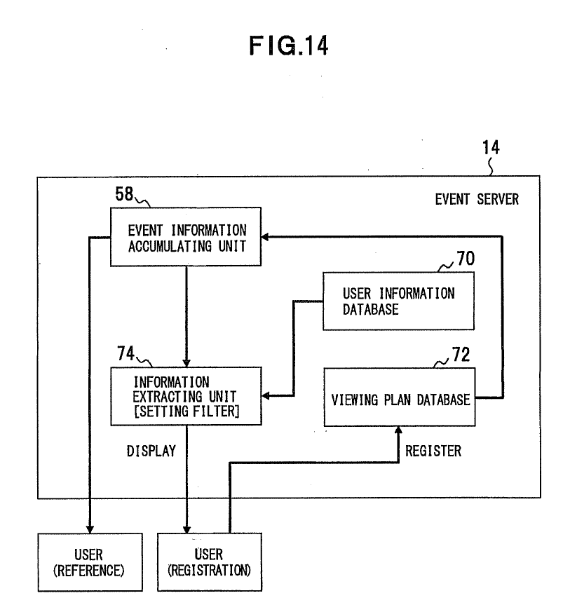

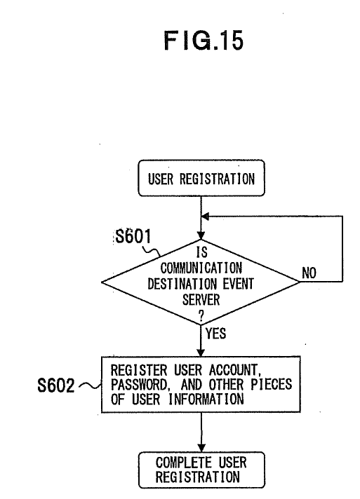

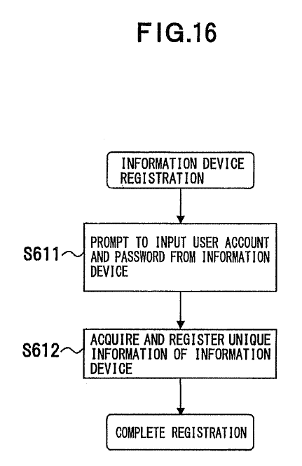

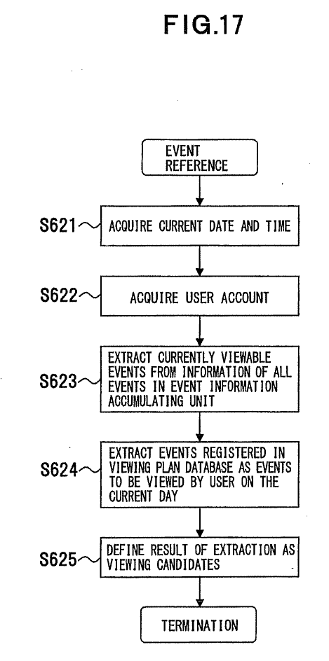

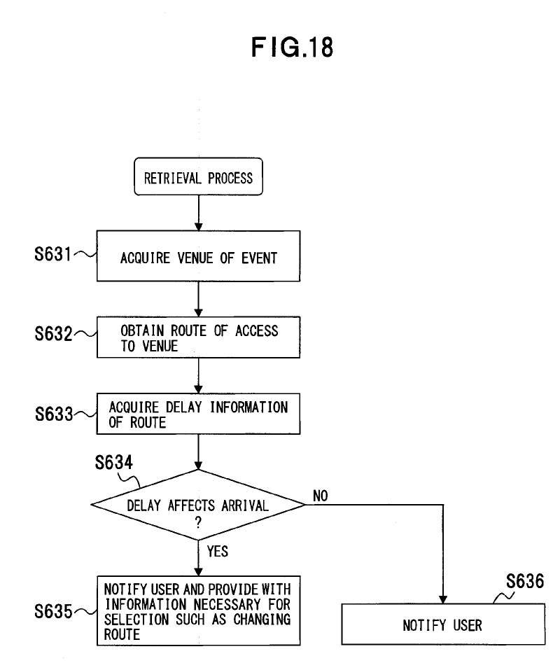

The event server will then be described with reference to FIGS. 14, 15, 16, 17, and 18. FIG. 14 is a diagram of an exemplary configuration of an event server; FIG. 15 is a flowchart of a user registration process procedure; FIG. 16 is a flowchart of an information device registration process procedure; FIG. 17 is a flowchart of an event reference process procedure; and FIG. 18 is a flowchart of an event information process procedure. The configurations depicted in FIGS. 14, 15, 16, 17, and 18 are by way of example and the present invention is not limited to these configurations. In FIG. 14, the same reference numerals are added to the same portions as FIG. 1.

The event server 14 is an example of the above described secondary server 10, and is an information providing means that, for example, accumulates information of various events at and around the destination station of the vehicle 4 and executes registration of user's schedule information and information representing selection conditions such as preferences to provide information in accordance with user's schedule and preference. The event server 14 includes an event information accumulating unit 58, a user information database 70, and a viewing plan database 72, and an information extracting unit 74, as depicted in FIG. 14.

The event information accumulating unit 58 is a mean of accumulating the event information and accumulates the information of various events registered through the network 16 (FIG. 1) or by a company establishing the event server 14, service providers, users, etc.

The user information database 70 is a registering means that registers user's individual schedule information, preferences, taste, etc., as user information for each user. The registration in the user information database 70 is performed through the above described user terminals 61, 62, . . . 6n. For example, a user registers a viewing plan, etc., as a schedule.

The viewing plan database 72 is a registering means that registers information about events to be viewed by users.

The information extracting unit 74 is a means that executes an information filtering process by setting a filter for selecting the provided information in accordance with selection conditions such as schedules and preferences as well as whether display is performed. In this filtering process, for example, the information required for the user is extracted from the entire event information in the event information accumulating unit 58. The output form thereof may be output as information and may be displayed on a displaying means of the user terminals 61, 62, . . . 6n, for example. In this case, the definition of the filter is performed while checking basically display after the extraction.

Although the event server 14 is a server accessible from users not only in the vehicle 4 but also at home and may basically be disposed as the own server of the service provider, an original server disposed by a user may be used as the event server 14. In this case, it is desirable that the server is always operated to enable access from the information aggregation server 8 at any time.

The process procedure of the event server 14 is an example of the information providing method or the information providing program and includes the user registration process (FIG. 15), the information device registration process (FIG. 16), the event information reference process (FIG. 17), the retrieval process (FIG. 18), etc.

In the user registration process, as depicted in FIG. 15, the user registration process is selected; it is determined whether the communication destination is the event server 14 (step S601); if the communication destination is the event server 14 (YES at step S601), a user account, a password, and other pieces of user information are registered as the user registration (step S602); and the user registration process is completed.

In the information device registration process procedure of the user terminals 61, 62, . . . 6n, as depicted in FIG. 16, it is prompted to input a user account and a password from the information device to be registered (step S611). The unique information of the information device is accordingly acquired and registered (step S612). The information device registration process is then completed.

In the event information reference process procedure, as depicted in FIG. 17, the current date and time are acquired (step S621) and a user account is acquired (step S622). Currently viewable events are extracted from the information of all the events in the event information accumulating unit 58 (step S623); events are extracted that are registered in the viewing plan database 72 as the events to be viewed by the user on the current day (step S624); and the result of extraction is defined as one or a plurality of viewing candidates (step S625). A reference is made to the event information based on the viewing candidates.

The retrieval process (FIG. 18) is executed for the acquired viewing candidates. In this retrieval process, information of the venue of the event is acquired (step S631). A route of access to the venue is obtained from the acquired information (step S632), and the delay information of the route is acquired (step S633). The delay information may be acquired by reference to the delay information, etc., in the main server 12.

It is determined based on the acquired delay information whether the delay affects arrival at the venue (step S634). If the delay affects arrival at the venue (YES at step S634), the user is notified and provided with information necessary for selection such as changing the route (step S635) and this process is terminated.

If the delay does not affect arrival at the venue (NO at step S634), the user is notified of the information (step S636), and the process is terminated.

Features, advantages, etc., will be listed for the information providing system 2A described above.

(1) Since the information aggregation server 8 is disposed in the vehicle as the information relaying means, information may stably be exchanged with the outside.

(2) A user (passenger) trying to acquire information may acquire appropriate information for the vehicle 4 that the user is currently taking, and the user may transmit the own identification code to the information aggregation server 8 of the vehicle 4 along with the acquired vehicle attribute information as an information provision request. The information aggregation server 8 may transmit the information provision request to the main server 12 and/or the event server 14 after adding appropriate information as needed.

(3) The main server 12 and/or the event server 14 receives the request from the user and provides information about the exit station (or stations the user may exit regardless of the intention to exit) to the user who makes the request.

(4) If the information representing selection conditions about user's preferences is preliminarily be registered, unnecessary information may be discarded from the information about the exit station as needed based on the preference conditions to provide necessary information to the user.

(5) The information providing system 2A has a symbol string or a graphic (identification symbol) for identifying a vehicle that is disposed within the vehicles 4 such as trains and buses and if an access is made with an identification symbol, etc., by a user of the vehicle 4, the accessing user terminal may be provided with information about the vehicle (vehicle attribute information) such as “line name”, “type”, “terminal station”, “vehicle number”, and “cause of delay and expected delay time in the case of delay” of the vehicle corresponding to the identification symbol, etc.

(6) The vehicle 4 includes a local area network using a means without transmission wires such as electromagnetic wave or infrared light to permit users (passengers) in the vehicle 4 to exchange information with the outside of the vehicle 4 through the network 15, etc., and if a user makes a request for connecting to an external information source, the vehicle attribute information about the vehicle 4 may entirely or partially be added to the information from the user (passenger) to achieve connection with the external information source, and the user may be provided with the vehicle attribute information about the vehicle 4.

(7) Information of stopping stations or stops (an exist station) and information of facilities around the stations may be provided in addition to the vehicle attribute information.

(8) If a user preliminarily registers information of the own preferences, only the information following the user's preferences may be extracted and provided from the provided information.

(9) Information may be provided with regard not only to stopping stations but also to the exit station by specifying the location of the exit station during or before a user takes a train.

(10) Information about surroundings of stations may easily be acquired while utilizing transportation facilities such as trains and highly convenient information may be acquired.

(11) Information may be constructed from a point available for a starting point of activity in terms of information provision to provide useful information for a user regardless of whether a point is not actually available for a starting point of activity in the current location or an arbitrary station.

(12) If operation schedule of a train is disrupted, delay information, etc., may be acquired in the train and a user may immediately respond, which contributes to ensuring of safety of activity.

### [b] Second Embodiment

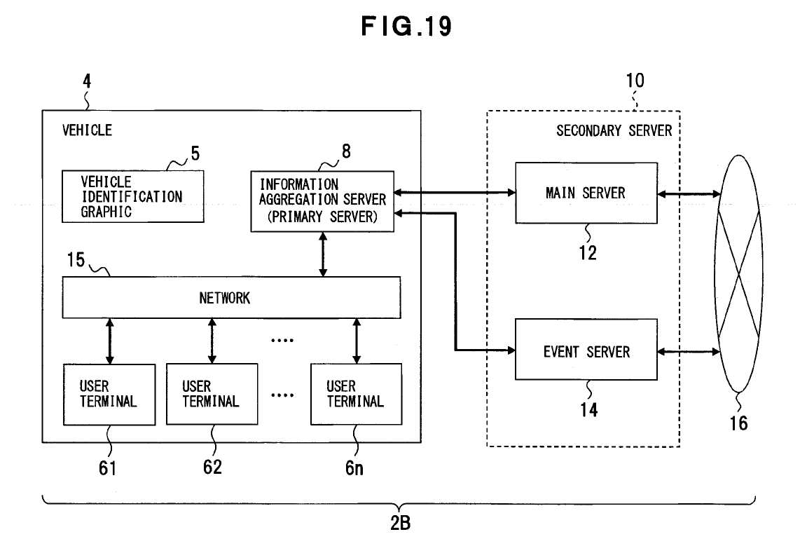

Although the information aggregation server 8 is connected only to the main server 12 in the information providing system 2A of the first embodiment, the information aggregation server 8 is directly connected to the event server 14 in an information providing system 2B of a second embodiment as depicted in FIG. 19. With such a configuration, the information aggregation server 8 and the event server 14 may rapidly transmit/receive information without the intervention of the main server 12. Since other constituent elements are the same as the information providing system 2A, these elements are given the same reference numerals and will not be described.

### [c] Third Embodiment

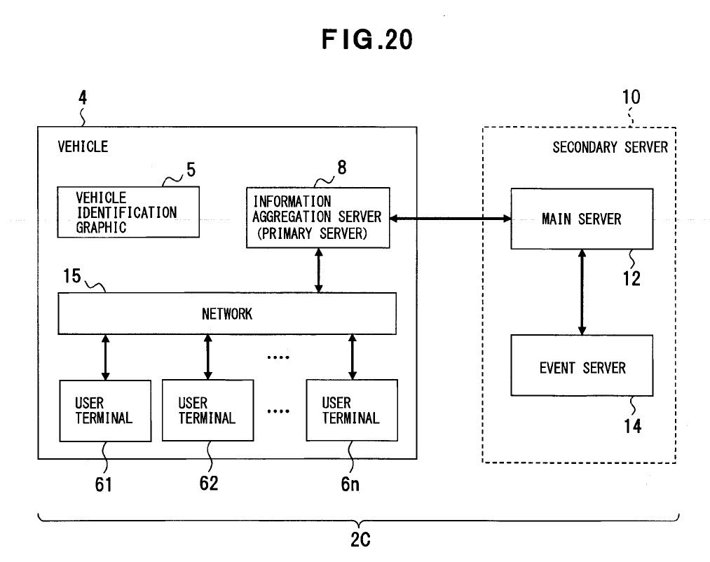

Although the main server 12 is connected through the network 16 such as the Internet in the information providing system 2A (FIG. 1) of the first embodiment, the main server 12 is directly connected to the event server 14 in an information providing system 2C of a third embodiment as depicted in FIG. 20. With such a configuration, the main server 12 and the event server 14 may rapidly transmit/receive information without the intervention of the network 16. Since other constituent elements are the same as the information providing system 2A, these elements are given the same reference numerals and will not be described.

### [d] Fourth Embodiment

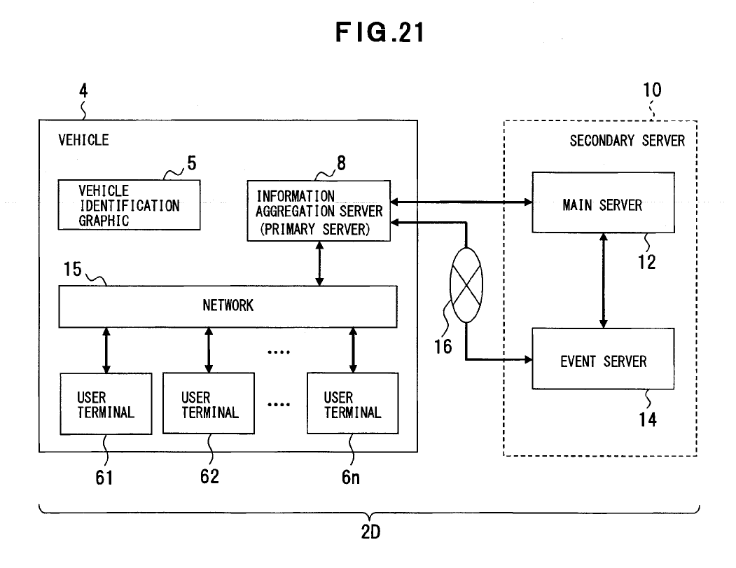

With regard to a connection relationship between the information aggregation server 8 and the event server 14, the information aggregation server 8 is connected to the event server 14 through the network 16 in an information providing system 2D of a fourth embodiment, as depicted in FIG. 21. With such a configuration, information maybe transmitted/received between the information aggregation server 8 and the event server 14. Since other constituent elements are the same as the information providing system 2A, these elements are given the same reference numerals and will not be described.

### [e] Fifth Embodiment

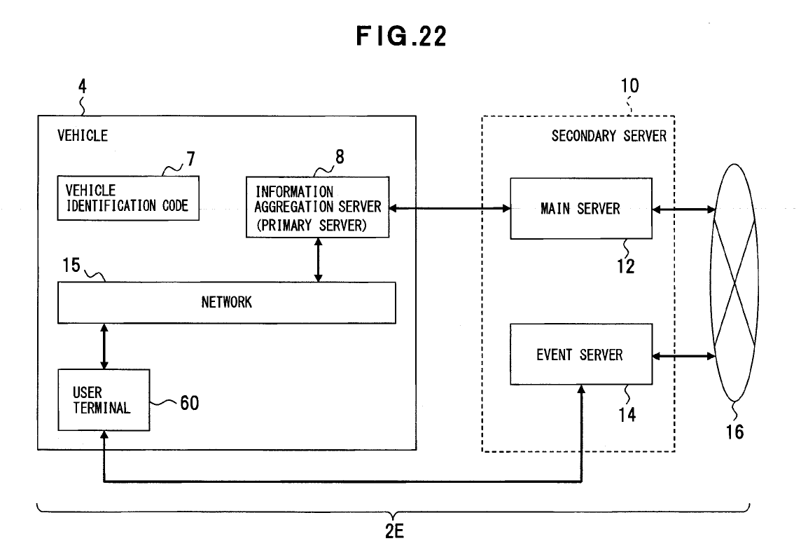

Although the user terminals 61, 62, . . . 6n are disposed separately from the event server 14 in the information providing system 2A (FIG. 1) of the first embodiment, a user terminal 60 and the event server 14 are configured as a single information device privately owned by a user in an information providing system 2E of the fifth embodiment as depicted in FIG. 22. A vehicle identification code 7 may be used instead of the vehicle identification graphic 5 (FIG. 1). Since other constituent elements are the same as the information providing system 2A, these elements are given the same reference numerals and will not be described.

### [f] Other Embodiments

(1) Although the vehicle 4 is exemplarily illustrated as the certain area in the above embodiments, the areas covered by the present invention are certain land areas, buildings, rooms thereof, various groups such as a group of people, or spaces, and are not limited to the above embodiments. Therefore, although the area identification information is vehicle identification information in the case of the vehicle 4, the information may be land area identification information in the case of a land area, building identification information in the case of a building, room identification information in the case of a room, and group identification information in the case of a group of people, and the attribute information for these areas may be vehicle attribute information for a vehicle, land area attribute information for a land area, building attribute information for a building, room attribute information for a room, and group attribute information for a group of people.

(2) With regard to the extraction of information to be acquired, the filtering process may be executed by any one of the main server 12, the event server 14, the information aggregation server 8, and the user terminals 61 to 6n and is not limited to the aspect of the embodiments.

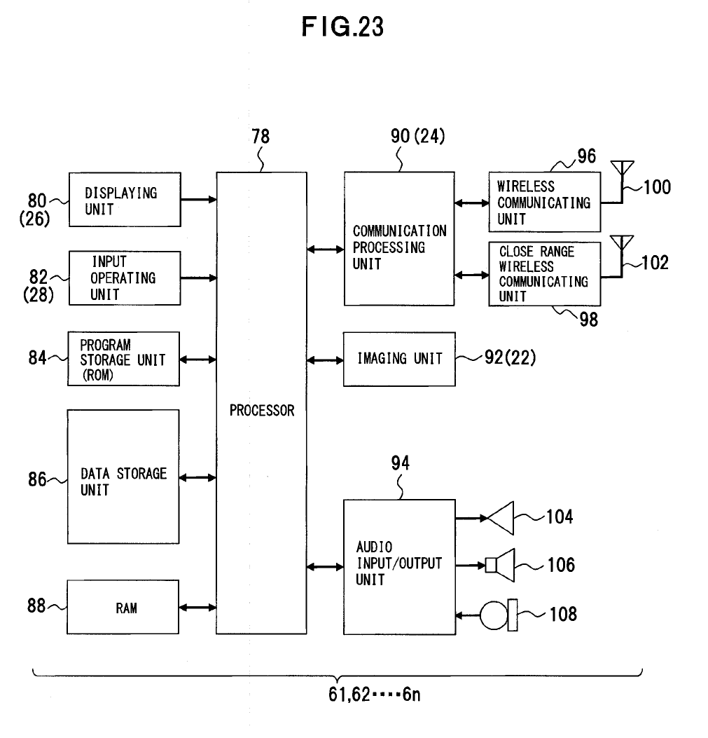

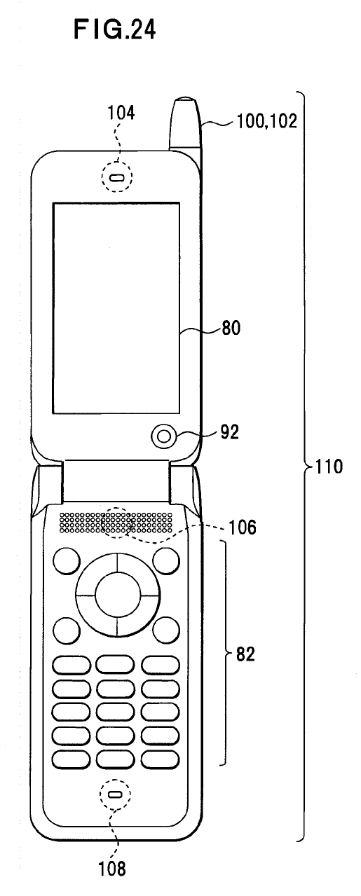

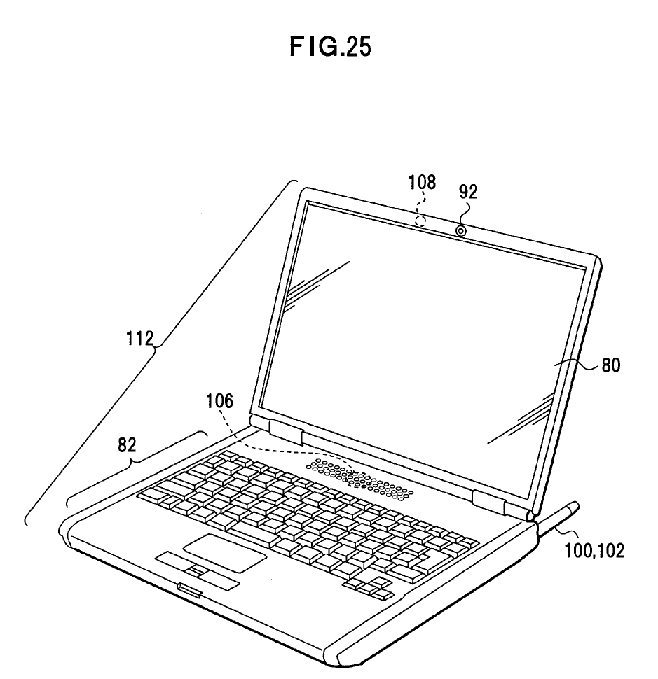

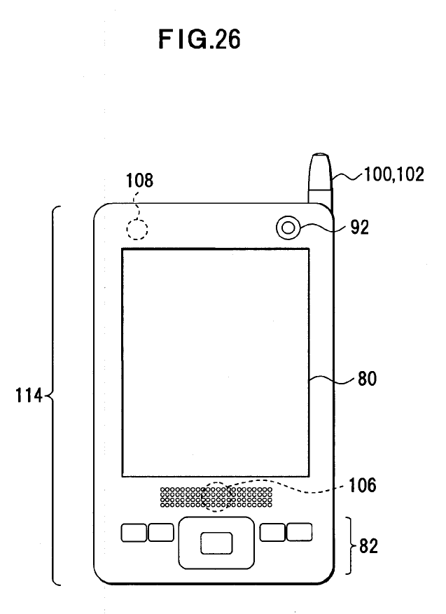

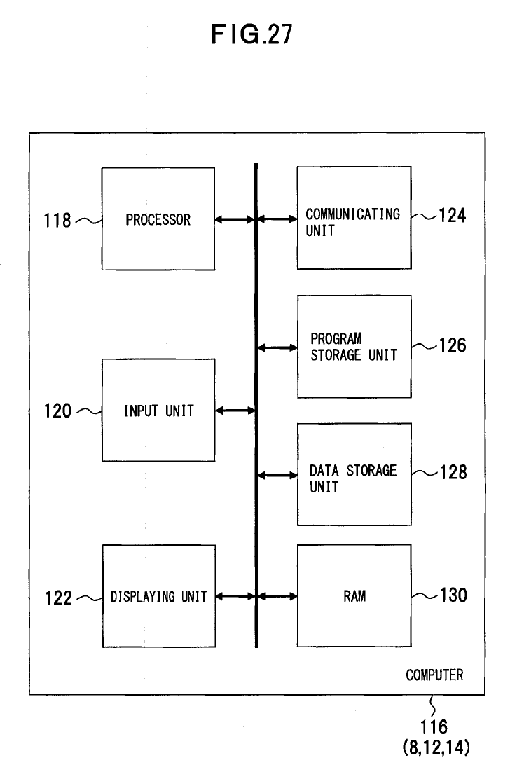

(3) The user terminals, the information aggregation servers, the main servers, and the event servers of the information providing systems 2A, 2B, 2C, 2D, and 2E will be described with reference to FIGS. 23, 24, 25, 26, and 27. FIG. 23 is a diagram of hardware of the user terminal; FIG. 24 is a diagram of a portable device; FIG. 25 is a diagram of a personal computer (PC); FIG. 26 is a diagram of a PDA; and FIG. 27 is a diagram of a computer. The configurations depicted in FIGS. 23, 24, 25, 26, and 27 are by way of example and the present invention is not limited to these configurations. In FIGS. 23 to 27, the same reference numerals are added to the same portions as FIGS. 1, 4, 9, 12, and 14.

The user terminals 61, 62, . . . 6n are computers having the communication function and include a processor 78, a displaying unit 80, an input operating unit 82, a program storage unit 84, a data storage unit 86, a RAM (random access memory) 88, a communication processing unit 90, an imaging unit 92, and an audio input/output unit 94 as depicted in FIG. 23.

The processor 78 executes OS (operating system) and application programs stored in the program storage unit 84, executes an information providing sub-routine of the above information providing program executed by the information terminal to acquire the information request and information corresponding to the information request, and executes control of various function units.

The input operating unit 82 is an information input means and is made up of a keyboard, etc. The program storage unit 84 is made up of a recording medium and has stored thereon the OS and various application programs as well as programs such as the information providing sub-routine above.

The data storage unit 86 is made up of a recording medium having stored thereon the unique information and user information of the information terminal and various acquired information. The RAM 88 is a work area. The communication processing unit 90 is a communicating means of wired communication, wireless communication, and close range wireless communication and is connected to a wireless communicating unit 96 and a close range wireless communicating unit 98 to control the communicating units 96 and 98. The wireless communicating unit 96 includes an antenna 100 to execute wireless communication to a base station by public lines. The close range wireless communicating unit 98 includes an antenna 102 to execute communication in accordance with the Bluetooth standard as well as communication through the network 15.

The imaging unit 92 is a camera function unit and is a means of imaging and capturing the vehicle identification graphic 5 as image information through image-taking.

The audio input/output unit 94 includes a receiver 104, a speaker 106, and a microphone 108 to reproduce sounds through the receiver 104 and/or the speaker 106 and to capture sounds through the microphone 108.

With such a hardware configuration, the above described device information setting unit 20 is made up of the input operating unit 82, the processor 78, the data storage unit 86, or the imaging unit 92; the vehicle identification information capturing unit 22 is made up of the imaging unit 92, the processor 78, or the input operating unit 82; the communication processing unit 24 is made up of the processor 78, the communication processing unit 90, the wireless communicating unit 96, or the close range wireless communicating unit 98; the displaying unit 26 corresponds to the displaying unit 80; and the input unit 28 is made up of the input operating unit 82, etc.

The above user terminal 61, 62, . . . 6n may be a mobile telephone 110 having the wireless communication function, the telephone communication function, and the information processing function as depicted in FIG. 24, a PC 112 having the same functions as depicted in FIG. 25, or a PDA 114 as depicted in FIG. 26. In FIGS. 24, 25, and 26, the same reference numerals are added to the same portions as FIG. 23 and will not be described.

The information aggregation server 8, the main server 12, or the event server 14 may be made up of a computer 116 (FIG. 27) having a communication function, an information accumulating function, an information retrieving function, etc. The computer 116 includes a processor 118, an input unit 120, a displaying unit 122, a communicating unit 124, a program storage unit 126, a data storage unit 128, and a RAM 130 as depicted in FIG. 27.

The processor 118 executes the OS, application programs, and the information providing program in the program storage unit 126 and controls each function unit. The communicating unit 124 executes the long range communication and the close range communication through the network 15 and the public lines under the control of the processor 118. The program storage unit 126 executes the OS, the application programs, and the information providing program. The data storage unit 128 is a recording means that has stored thereon the unique information and various pieces of the acquired information.

If the computer 116 makes up the information aggregation server 8 (FIG. 9), the data storage unit 128, etc., make up the vehicle unique information accumulating unit 30, the session ID assigning unit 36, and the terminal communication buffer 34 above, and the communicating unit 124 makes up the main-server communicating unit 32 and the terminal communicating unit 38. In this case, the processor 118 executes the process of the information providing program and executes, for example, a sub-routine of the information relaying process assigned to the information aggregating server 8.

If the computer 116 makes up the main server 12 (FIG. 12), the communicating unit 124 makes up the information aggregation server communicating unit 42, the event server communicating unit 52, and the control information acquiring unit 56; the processor 118, the communicating unit 124, etc., make up the above described point passing time acquiring unit 44; the processor 118 makes up the comparing unit 50; the data storage unit 128 makes up the time tables 46 and 48; and the processor 118, the program storage unit 126, the RAM 130, etc., make up the control information processing device 54. In this case, the processor 118 executes the process of the information providing program and executes, for example, the acquisition of the information assigned to the main server 12, the information selection process, and the sub-routine of the provision process.

If the computer 116 makes up the event server 14 (FIG. 14), the data storage unit 128 makes up the event information accumulating unit 58, the user information database 70, and the viewing plan database 72; the information extracting unit 74 is made up of the processor 118, the program storage unit 126, the data storage unit 128, and the RAM 130; and the filter setting information is stored in the data storage unit 128. In this case, the processor 118 executes the process of the information providing program and executes, for example, the acquisition of the information assigned to the event server 14, the information selection process, and the sub-routine of the provision process.

(4) Although the vehicle 4 is exemplarily illustrated as an example of the storage means of the area identification information in the above embodiments, the storage means of the area identification information may be an electronic means as well as a means sectionalizing an area such as the vehicle 4 and may be a recording medium if the area identification information is electronic information and, for example, the data storage unit 128 of the computer 116 making up the information aggregation server 8 may be used for the storage means of the area identification information. An IC (integrated circuit) tip may be used for the storage means of the area identification information.

Matters extracted from the embodiments are listed below.

In the information providing apparatus, preferably, if the area is a vehicle, the area attribute information may include at least any one of a line, a terminal station, a vehicle number, delay information, an expected delay time of the vehicle.

In the information providing apparatus, preferably, the area may include an information relaying unit that transmits and receives information through a network to/from the information terminals and/or the information providing unit, and the information relaying unit may add all or a part of the area identification information to the information request including the area identification information from the information terminal, may connect to the information providing unit, and may provide information acquired from the information providing unit to the information terminal.

With such a configuration, since the information relaying unit is disposed in the area, the information request may be accepted through the information relaying unit and the area attribute information may be acquired for the information request to stably and rapidly provide the attribute information to the information terminal.

In the information providing apparatus, preferably, the information providing unit may include a first information source that provides first information, which is specified by the area information, to the information relaying unit, and one or a plurality of second information sources that provide the first information of the first information source or second information concerning registration information of an information terminal user.

In the information providing apparatus, preferably, the area may be a vehicle, and the area attribute information may be vehicle attribute information concerning operation of the vehicle or information obtained by adding information about a stopping station and surrounding facilities to the vehicle attribute information.

In the information providing apparatus, preferably, the information terminal user may register a selection condition into the second information source, and information selected with the selection condition may be provided to the information relaying unit.

In the information providing system, preferably, if the area is a vehicle, the area attribute information may include at least any one of a line, a terminal station, a vehicle number, delay information, an expected delay time of the vehicle.

In the information providing system, preferably, the area may include an information relaying unit that transmits and receives information through a network to/from the information terminals and/or the information providing unit, and the information relaying unit may add all or a part of the area identification information to the information request including the area identification information from the information terminal, may connect to the information providing unit, and may provide information acquired from the information providing unit to the information terminal.

In the information providing system, preferably, the information providing unit may include a first information source that provides first information, which is specified by the area information, to the information relaying unit, and one or a plurality of second information sources that provide the first information of the first information source or second information concerning registration information of an information terminal user.

In the information providing system, preferably, the area may be a vehicle, and the area attribute information may be vehicle attribute information concerning operation of the vehicle or information obtained by adding information about a stopping station and surrounding facilities to the vehicle attribute information.

In the information providing system, preferably, the information terminal user may register a selection condition into the second information source, and information selected with the selection condition may be provided to the information relaying unit.

The features and the effects of the present embodiments are listed as follows.

(1) When an information request including area identification information is issued from an information terminal existing in an area, area attribute information concerning the area may be stably and rapidly provided to the information terminal.

(2) If an information relaying means is included in the area, information acquired from an information source outside of the area may be stably and rapidly provided through the information relaying means in response to an information request from an information terminal existing in the area.

(3) If the area is, for example, a vehicle, information about the destination station, the surrounding thereof, etc., may easily be acquired in response to an information request including the area identification information from an information terminal in the vehicle and may be provided to the information terminal, and immediate action may be taken if the operation schedule of the train is disrupted.

The embodiments of the present invention relate to information provision to terminals within a certain area such as a vehicle or building and are useful because when an information request including the area identification information is issued from an information terminal existing in a certain area such as a vehicle and a building, the embodiments of the invention may stably and rapidly provide to the information terminal the area attribute information concerning the area such as diagram information, route information, and transfer information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information providing apparatus comprising:
a storage unit that stores thereon area identification information identifying an area in which the information providing apparatus is disposed; and
an information providing unit that provides area attribute information concerning at least the area toward one or a plurality of information terminals that issue information requests including the area identification information.

2. The information providing apparatus of claim 1, wherein
if the area is a vehicle, the area attribute information includes at least any one of a line, a terminal station, a vehicle number, delay information, an expected delay time of the vehicle.

3. The information providing apparatus of claim 1, wherein:
the area includes an information relaying unit that transmits and receives information through a network to/from the information terminals and/or the information providing unit, and
the information relaying unit adds all or a part of the area identification information to the information request including the area identification information from the information terminal, connects to the information providing unit, and provides information acquired from the information providing unit to the information terminal.

4. The information providing apparatus of claim 3, wherein
the information providing unit includes
a first information source that provides first information, which is specified by the area information, to the information relaying unit, and
one or a plurality of second information sources that provide the first information of the first information source or second information concerning registration information of an information terminal user.

5. The information providing apparatus of claim 1, wherein
the area is a vehicle, and the area attribute information is vehicle attribute information concerning operation of the vehicle or information obtained by adding information about a stopping station and surrounding facilities to the vehicle attribute information.

6. The information providing apparatus of claim 4, wherein
the information terminal user registers a selection condition into the second information source, and information selected with the selection condition is provided to the information relaying unit.

7. An information providing method comprising:
acquiring area identification information of a certain area;
issuing an information request including the area identification information from an information terminal; and
providing area attribute information concerning at least the area from an information providing unit toward the information terminal.

8. A computer-readable storage medium storing an information providing program executable by a computer, the program comprising the steps of:
acquiring area identification information of a certain area;
issuing an information request including the area identification information from an information terminal; and
providing area attribute information concerning at least the area from an information providing unit to the information terminal.

9. An information providing system providing information to information terminals at least within an area, comprising:
a storage unit that stores thereon area identification information identifying the area;
one or a plurality of information terminals that issue information request including the area identification information to acquire information corresponding to the information request;
an information providing unit that provides area attribute information concerning at least the area when the information terminal issues the information request; and
an information relaying unit that is disposed in the area, is connected to the information terminal and/or the information providing unit through a network, and relays the information request issued from the information terminal and response information provided from the information providing unit in response to the information request.

10. The information providing system of claim 9, wherein
if the area is a vehicle, the area attribute information includes at least any one of a line, a terminal station, a vehicle number, delay information, an expected delay time of the vehicle.

11. The information providing system of claim 9, wherein:
the area includes an information relaying unit that transmits and receives information through a network to/from the information terminals and/or the information providing unit, and
the information relaying unit adds all or a part of the area identification information to the information request including the area identification information from the information terminal, connects to the information providing unit, and provides information acquired from the information providing unit to the information terminal.

12. The information providing system of claim 11, wherein
the information providing unit includes
a first information source that provides first information, which is specified by the area information, to the information relaying unit, and
one or a plurality of second information sources that provide the first information of the first information source or second information concerning registration information of an information terminal user.

13. The information providing system of claim 9, wherein
the area is a vehicle, and the area attribute information is vehicle attribute information concerning operation of the vehicle or information obtained by adding information about a stopping station and surrounding facilities to the vehicle attribute information.

14. The information providing system of claim 12, wherein
the information terminal user registers a selection condition into the second information source, and information selected with the selection condition is provided to the information relaying unit.
